(19) United States
(12) Patent Application Publication
(10) Pub. No.: US 2013/0220066 A1
(43) Pub. Date: Aug. 29, 2013

(54) BIKE AUXILIARY HANDLE CONNECTION DEVICE

(71) Applicant: YAO-CHING HUANG, Taichung City (TW)

(72) Inventor: YAO-CHING HUANG, Taichung City (TW)

(21) Appl. No.: 13/402,969

(22) Filed: Feb. 23, 2012

(51) Int. Cl. B62K 21/16

(52) U.S. Cl. 74/551.3

(57) ABSTRACT

A bike auxiliary handle connection device includes a main body and an adjustment unit. The main body has a guide trough and adjustment holes. The adjustment unit includes two receiving seats and two adjustment bolts. The two receiving seats have guide blocks at inner sides thereof. The guide blocks are inserted in the guide trough the main body. The guide blocks have threaded holes thereon. The two adjustment bolts are inserted through the main body and screwed to the threaded holes of the guide blocks. The two receiving seats of the adjustment unit are fitted on the front ends of the two parallel auxiliary handles. The connection device can be adjusted along with the adjustment of the distance of the two auxiliary handles.

### BACKGROUND OF THE INVENTION

1. Field of the Invention

The present invention relates to a bike auxiliary handle connection device, and more particularly to a connection device which can be adjusted along with the adjustment of the distance of the two auxiliary handles.

2. Description of the Prior Art

As shown in FIG. 1, conventional bike auxiliary handles 2 made in the form of a pipe are parallel to each other. The rear ends 21 of the auxiliary handles 2 are connected to a main handle 3, so that the front ends 22 of the two auxiliary handles 2 faces frontward. The main handle 3 comprises a pair of arm rest seats 4 disposed close to outer sides of the auxiliary handles 2. When riding, the rider can hold the main handle 3 or the front ends 22 of the two auxiliary handles 2 after a period of time, with his/her elbows to rest on the arm rest seats 4.

The rear ends 21 of the auxiliary handles 2 are connected to the main handle 3, and the front ends 22 of the two auxiliary handles 2 faces frontward. Each auxiliary handle 2 is independent, and the front end 22 is a free end. When the rider holds the front ends 22 of the auxiliary handles 2 for bike riding, the front ends 22 of the auxiliary handles 2 are shaken easily because the rider applies a certain force on the front ends 22 of the auxiliary handles 2.

As shown in FIG. 2 to FIG. 4, a connection device 5 is developed to overcome the aforesaid shortcomings of the auxiliary handles 2. The connection device 5 comprises two posts 51 extending from two rear ends thereof. Each post 51 has an inclined surface 511 at a bottom thereof. The connection device 5 has two through holes 53 corresponding to the two posts 51 for insertion of screws 52 disposed at the front ends of the connection device 5. Two connection blocks 54 are provided, each having a diameter corresponding to that of the post 51 and having an inclined surface 541 corresponding to the inclined surface 511 of the post 51. Each connection block 54 has a threaded hole 542 therein. The screws 52 are inserted through the through holes 53 and screw to the threaded holes 542 of the connection blocks 54, such that the two posts 51 at the rear ends of the connection device 5 are inserted into the front openings 23 of the two parallel auxiliary handles 2. The screws 52 bring the connection blocks 54 to move upward. Through the inclined surfaces 511, 541 of the posts 51 and the connection blocks 54 of the connection device 5, the circumferential surfaces of the posts 51 and the connection blocks 54 are tightly against the inner walls of the front openings 23 of the two auxiliary handles 2. The two rear ends of the connection device 5 are connected to the front openings 23 of the two auxiliary handles 2, and then the rear ends 21 of the two auxiliary handles 21 are connected to the main handle 3. The front openings 23 of the two auxiliary handles 2 are connected with the connection device 5 and the rear ends 21 are connected with the main handle 3, having a stable connection. The rider can rest his/her elbows on the arm rest seats 4. When the rider holds the front ends 22 of the auxiliary handles 2 for bike riding, the connection device provides a stable holding for both hands.

The aforesaid connection device 5 doesn't have any adjustment configuration. The two rear ends of the connection device 5 are connected to the front openings 23 of the two parallel auxiliary handles 2. The rear ends 21 of the two auxiliary handles 2 are coupled to the main handle 3. However, different users have different lengths of both hands. In addition, the riders may have different riding gestures and grasp positions. Because the two rear ends of the connection device 5 are connected to the front openings 23 of the two auxiliary handles 2, the distance between the two auxiliary handles 2 cannot be adjusted. When the rider holds the auxiliary handles 2 connected with the connection device 5, he/she may feel uncomfortable.

As shown in FIG. 5 and FIG. 6, for a long distance of riding, the front openings 23 of the two auxiliary handles 2 are provided with a pair of insertion-type brake handles 6 which are prior art and won't be descried in detail hereinafter. When the rider holds the auxiliary handles 2, he/she can brake his/her bike with the insertion-type brake handles 6 instead of the brake handles at the two ends of the main handle 3.

The two rear ends of the aforesaid connection device 5 are connected to the front openings 23 of the two auxiliary handles 2, so the front openings 23 of the two auxiliary handles 2 connected with the connection device 5 cannot be further connected with the insertion-type brake handles 6.

Accordingly, the inventor of the present invention has devoted himself based on his many years of practical experiences to solve these problems.

### SUMMARY OF THE INVENTION

The primary object of the present invention is to provide a bike auxiliary handle connection device for connection of the front ends of two auxiliary handles. The connection device can be adjusted along with the adjustment of the distance of the two auxiliary handles.

In order to achieve the aforesaid object, the bike auxiliary handle connection device comprises a main body and an adjustment unit. The main body has a guide trough at a bottom thereof and a pair of adjustment holes on a top thereof. The adjustment holes communicate with the guide trough. The adjustment unit comprises two receiving seats and two adjustment bolts. Each receiving seat has a receiving hole and a guide block at an inner side thereof. The guide block has a threaded hole thereon. Each receiving seat has a slot formed between the insertion hole and the guide block. The guide blocks at the inner sides of the two receiving seats are inserted in the guide trough at the bottom of the main body. The two adjustment bolts are inserted through the adjustment holes at the top of the main body and screwed to the threaded holes of the guide blocks of the two receiving seats. The receiving holes of the two receiving seats of the adjustment unit are fitted on the front ends of the two parallel auxiliary handles. The distance between the two auxiliary handles can be adjusted as desired by the guide blocks at the inner sides of the two receiving seats to slide along the guide trough at the bottom of the main body. The present invention provides a stable configuration for the rider to rest his/her both hands.

### BRIEF DESCRIPTION OF THE DRAWINGS

FIG. 1 is a perspective view showing connection of the auxiliary handles and the main handle of a conventional bike;

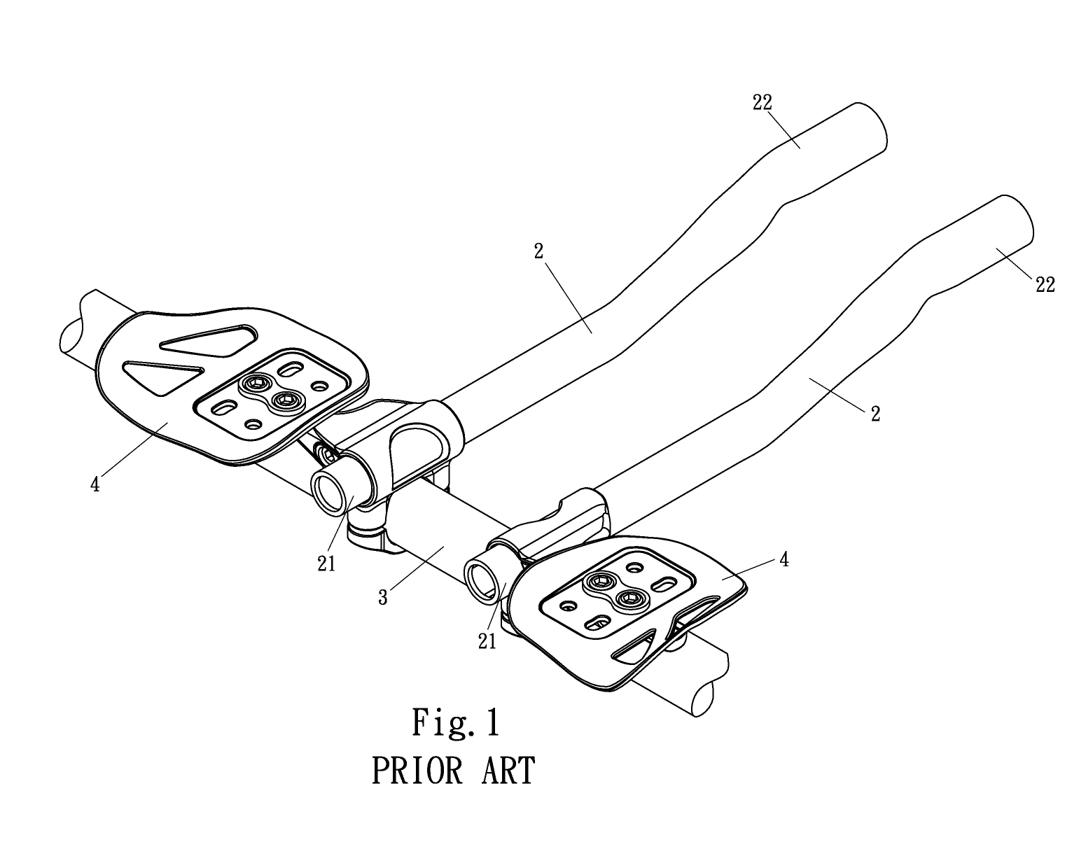

FIG. 2 is an exploded view showing the auxiliary handles and the main handle of the conventional bike;

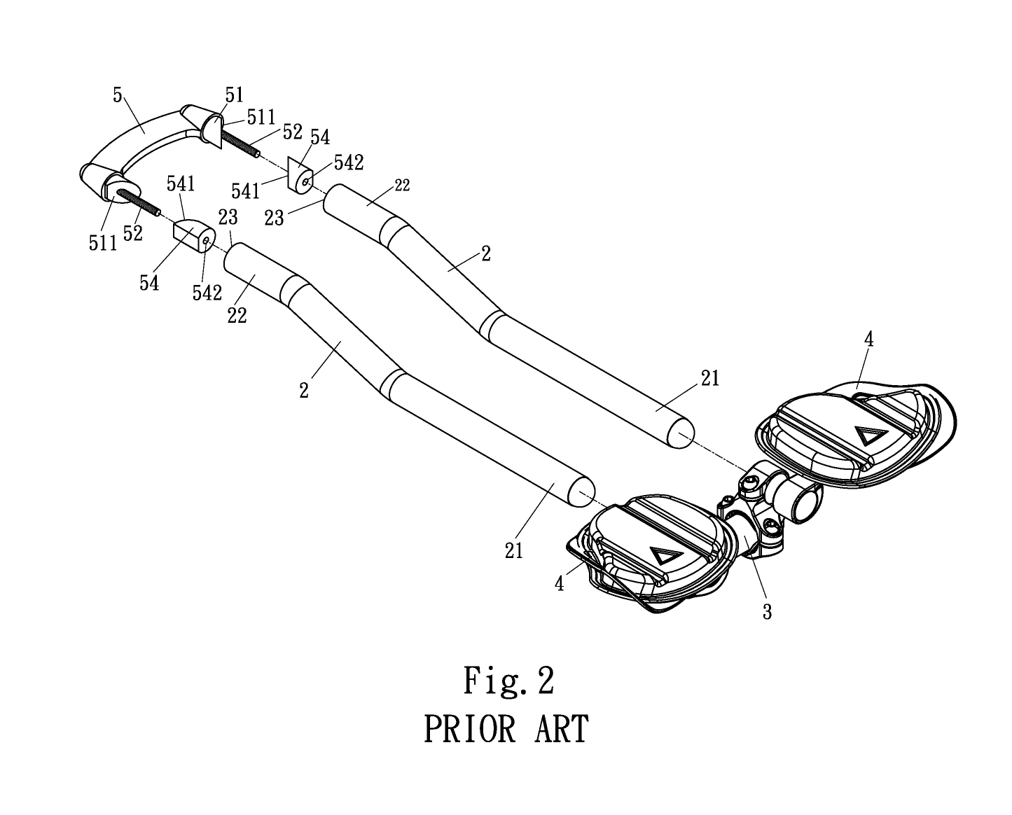

FIG. 3 is a sectional view of a conventional bike auxiliary handle connection device;

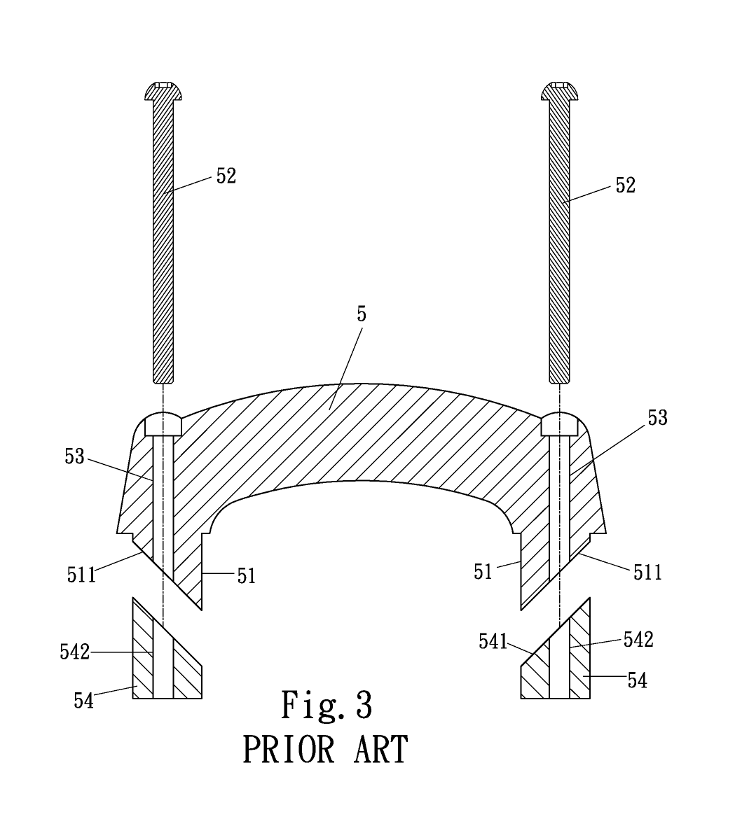

FIG. 4 is a perspective view of FIG. 2;

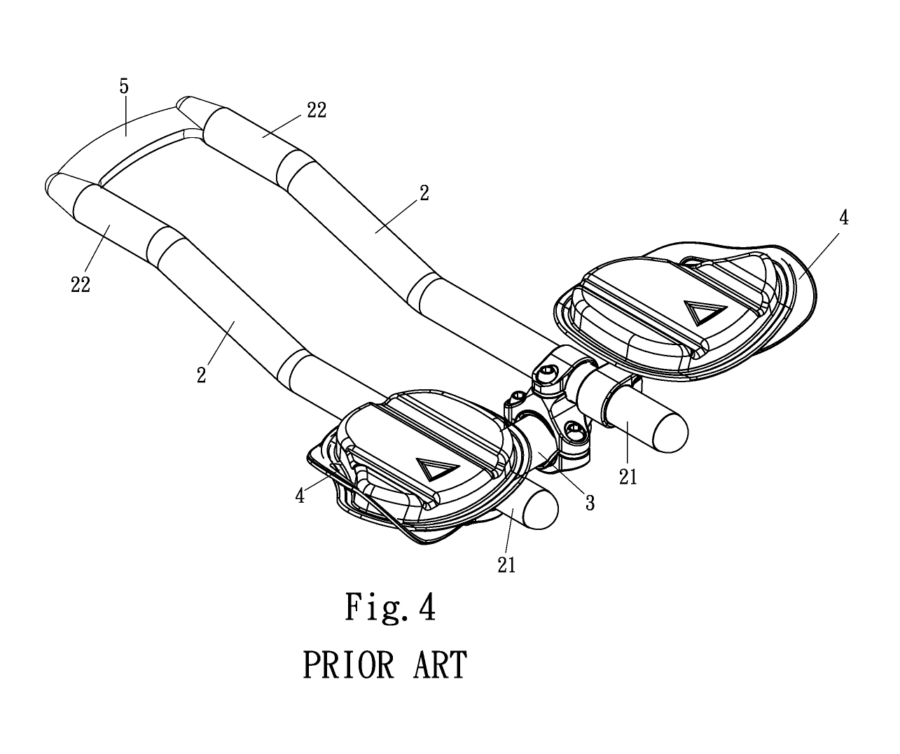

FIG. 5 is an exploded view showing another embodiment of the conventional bike auxiliary handles;

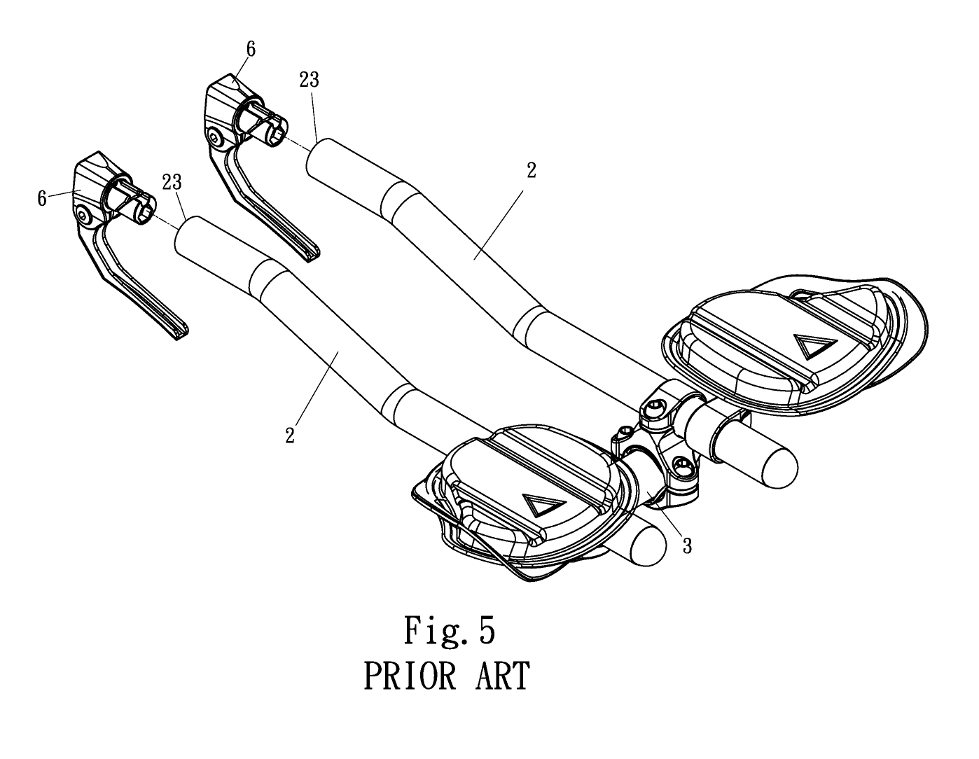

FIG. 6 is a perspective view of FIG. 5;

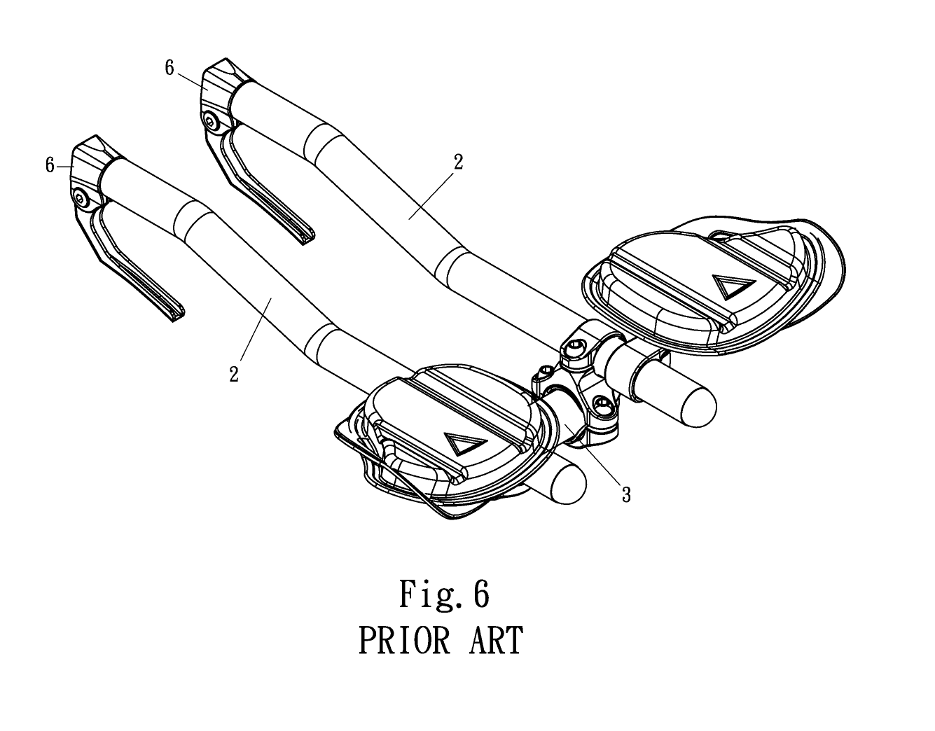

FIG. 7 is an exploded view of the bike auxiliary handle connection device of the present invention;

FIG. 8 is a perspective view of FIG. 7;

FIG. 9 is a schematic view showing the connection device of the present invention, the auxiliary handles and the main handle;

FIG. 10 is a sectional view showing the joint of the connection device and the front ends of the auxiliary handles (the two parallel auxiliary handles are adjusted to a minimum distance);

FIG. 11 is a sectional view showing the joint of the connection device and the front ends of the auxiliary handles (the two parallel auxiliary handles are adjusted to a maximum distance);

FIG. 12 is a perspective view of FIG. 9;

FIG. 13 is an exploded view showing another embodiment of the bike auxiliary handle connection device of the present invention; and

FIG. 14 is a perspective view of FIG. 13.

### DETAILED DESCRIPTION OF THE PREFERRED EMBODIMENTS

Embodiments of the present invention will now be described, by way of example only, with reference to the accompanying drawings.

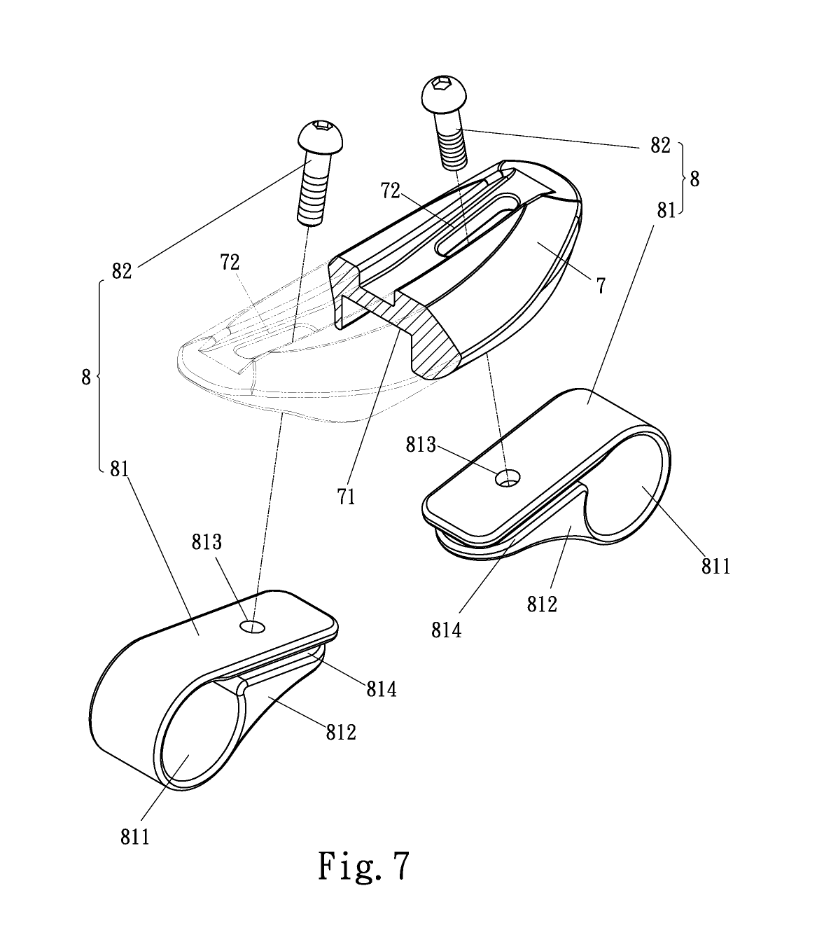

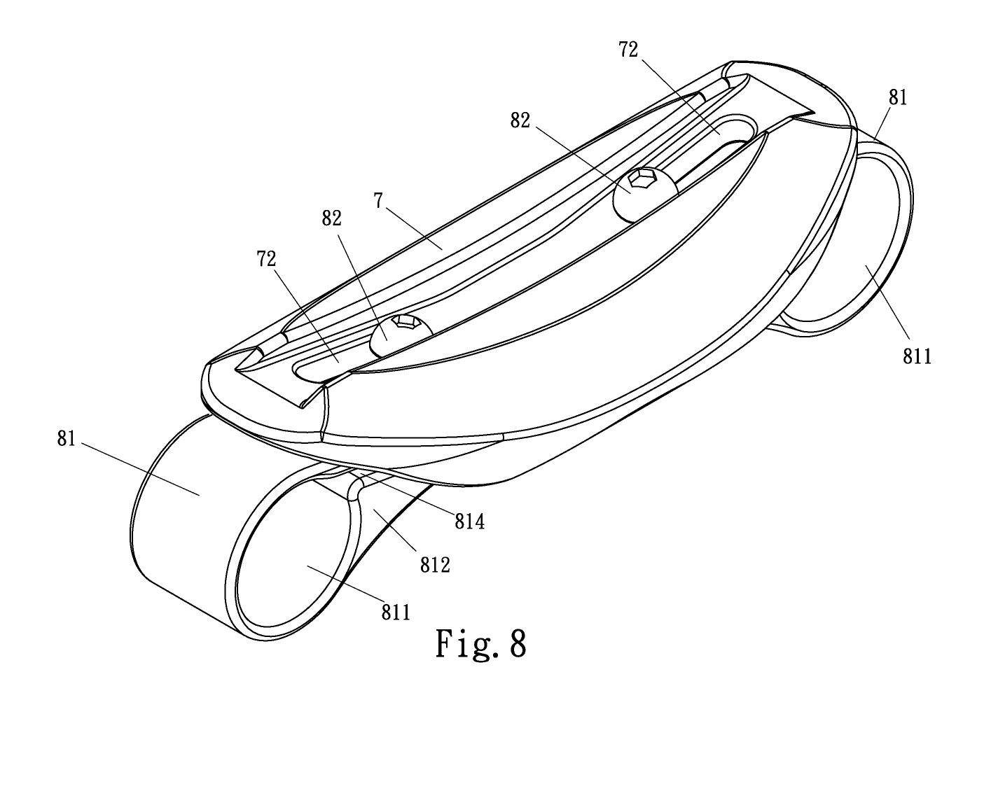

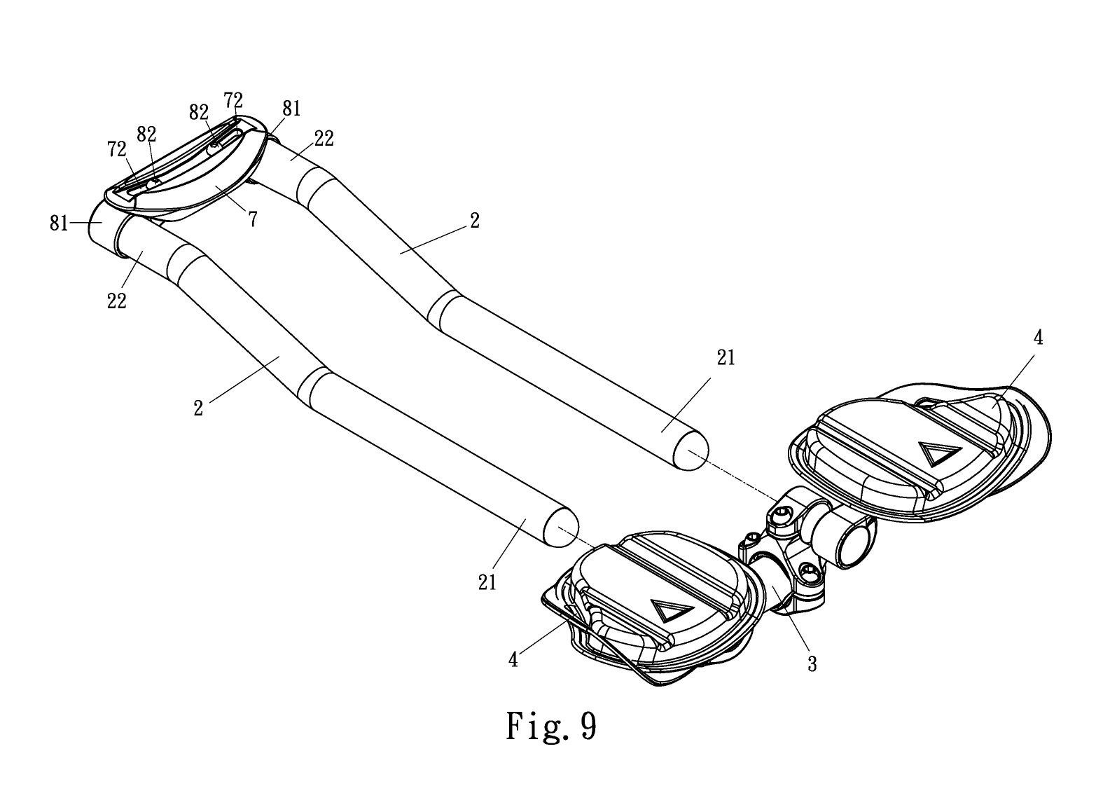

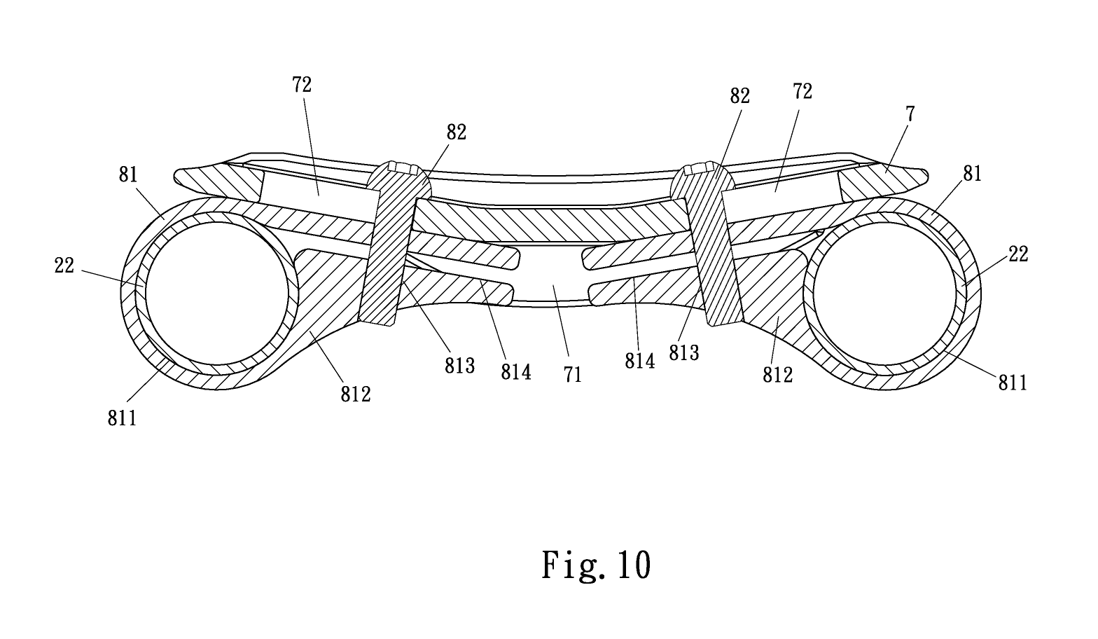

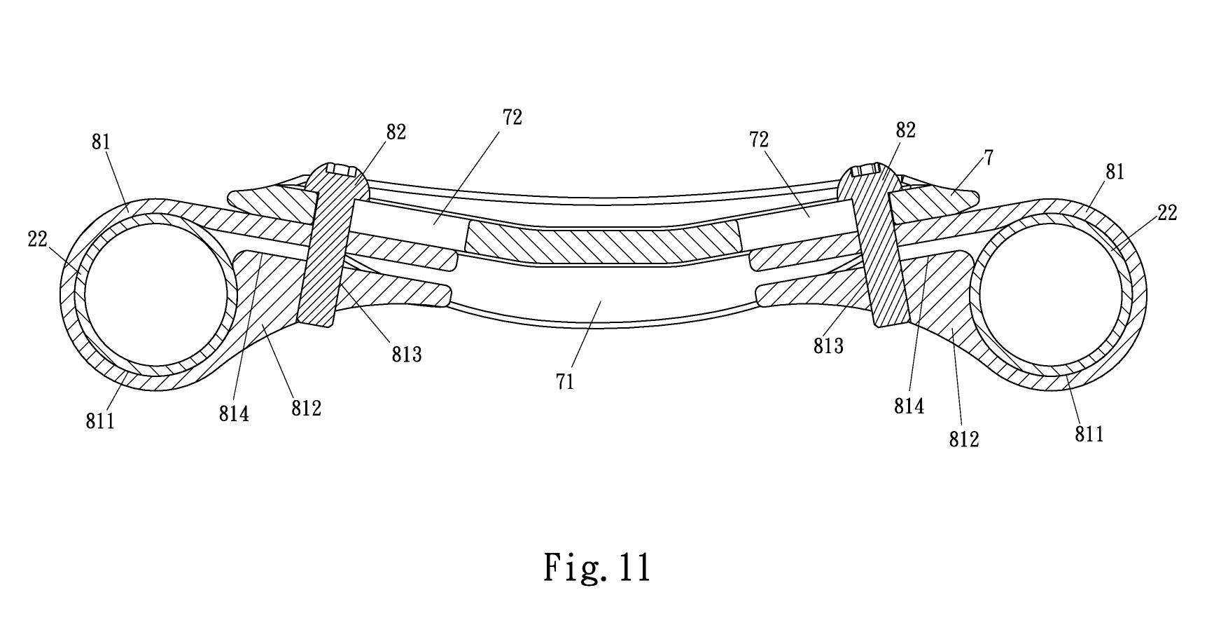

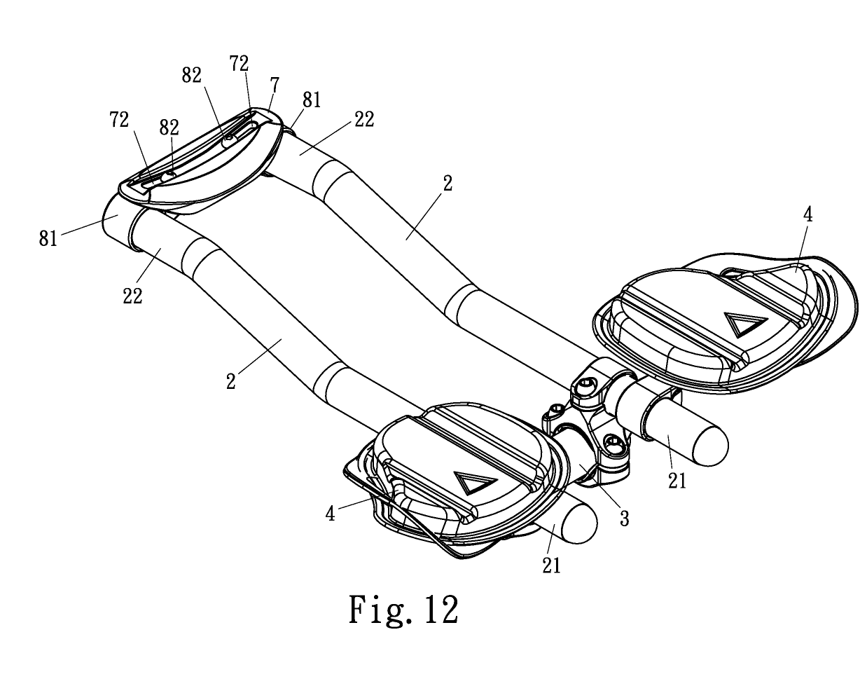

As shown in FIG. 7 through FIG. 14, the bike auxiliary handle connection device according to a preferred embodiment of the present invention comprises a main body 7 and an adjustment unit 8.

The main body 7 has a guide trough 71 at a bottom thereof and a pair of adjustment holes 72 on the top of two ends thereof. The adjustment holes 72 communicate with the guide trough 71.

The adjustment unit 8 comprises two receiving seats 81 and two adjustment bolts 82. Each receiving seat 81 has a receiving hole 811 and a guide block 812 at an inner side thereof. The guide block 812 has a threaded hole 813 thereon. Each receiving seat 81 has a slot 814 formed between the insertion hole 811 and the guide block 812. The guide blocks 812 at the inner sides of the two receiving seats 81 are inserted in the guide trough 71 at the bottom of the main body 7. The two adjustment bolts 82 are inserted through the adjustment holes 72 at the two ends of the main body 7 and screwed to the threaded holes 813 of the guide blocks 812 of the two receiving seats 81.

When in use, the adjustment bolts 82 of the adjustment unit 8 are inserted through the adjustment holes 72 at the two ends of the main body 7 and screwed to the threaded holes 813 of the guide blocks 812 of the two receiving seats 81. The receiving holes 811 of the two receiving seats 81 of the adjustment unit 8 are fitted on the front ends 22 of the two parallel auxiliary handles 2. The distance between the two auxiliary handles 2 can be adjusted as desired by the guide blocks 812 at the inner sides of the two receiving seats 81 to slide along the guide trough 71 at the bottom of the main body 7. After the two auxiliary handles 2 are adjusted to a desired position, the adjustment bolts 82 are tightly locked to connect the main body 7, the receiving seats 82 of the adjustment unit 8 and the auxiliary handles 2, such that the connection device is coupled to the front ends 22 of the two auxiliary handles 2. After that, the rear ends 21 of the two auxiliary handles 2 are coupled to the main handle 3, so the front and rear ends 22, 21 of the auxiliary handles 2 can be connected steady. The user can rest his/her elbows on the arm rest seats 4. The user can hold the front ends 22 of the auxiliary hands 2 when riding the bike.

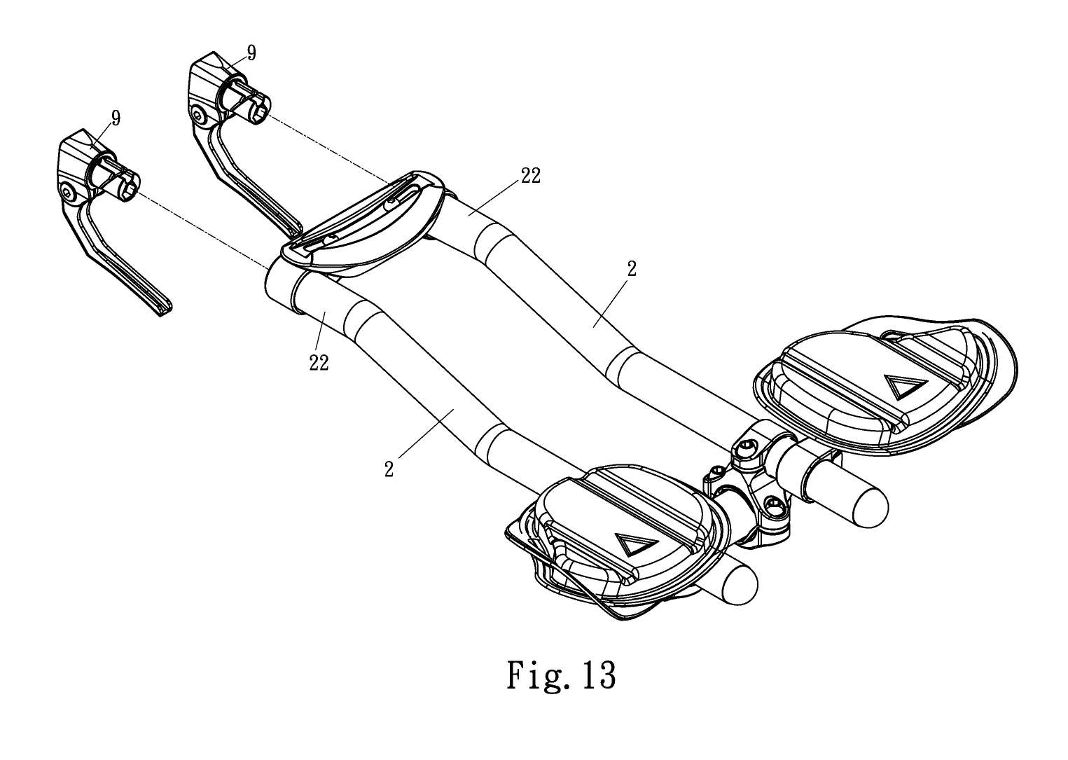

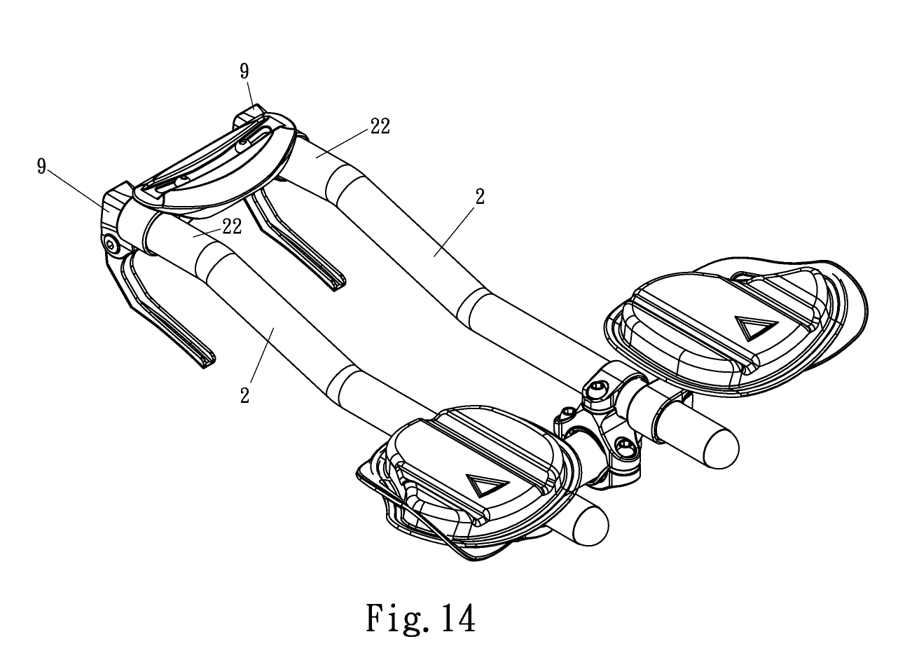

As shown in FIG. 13 and FIG. 14, the bike auxiliary handle connection device of the present invention is coupled to the front ends 22 of the two parallel auxiliary handles 2. The endmost opening of the auxiliary handle 2 can be inserted with an insertion-type brake handle 9 for the user to brake the bike, if necessary. It is convenient to install and operate the insertion-type brake handle 9.

The present invention overcomes the drawbacks of the prior art. The effects and advantages of the present invention are obvious

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bike auxiliary handle connection device, comprising:
a main body having a guide trough at a bottom thereof and a pair of adjustment holes on a top thereof, the adjustment holes communicating with the guide trough; and
an adjustment unit comprising two receiving seats and two adjustment bolts, the two receiving seats each having a receiving hole and a guide block at an inner side thereof, the guide block having a threaded hole thereon, the two receiving seats each having a slot formed between the insertion hole and the guide block, the guide blocks at the inner sides of the two receiving seats being inserted in the guide trough at the bottom of the main body, the two adjustment bolts being inserted through the adjustment holes at the top of the main body and screwed to the threaded holes of the guide blocks of the two receiving seats.

2. The bike auxiliary handle connection device as claimed in claim 1, wherein the adjustment holes are disposed on the top of two ends of the main body.
